(19) United States
(12) Patent Application Publication
(10) Pub. No.: US 2026/0037151 A1
(43) Pub. Date: Feb. 5, 2026

(54) CROSS-TEMPERATURE RANGE MANAGEMENT IN MEMORY SYSTEMS

(71) Applicant: Micron Technology, Inc., Boise, ID (US)

(72) Inventors: Dionisio Minopoli, Frattamaggiore (NA) (IT); Ting Luo, Santa Clara, CA (US); Luca Porzio, Casalnuovo (NA) (IT); Giuseppe Ferrari, Napoli (IT)

(21) Appl. No.: 19/277,062

(22) Filed: Jul. 22, 2025

Related U.S. Application Data
(60) Provisional application No. 63/677,331, filed on Jul. 30, 2024.

(51) Int. Cl. G06F 3/06

(52) U.S. Cl. CPC G06F 3/0619; G06F 3/0653; G06F 3/0659; G06F 3/0679

(57) ABSTRACT

Methods, systems, and devices for cross-temperature range management in memory systems are described. One or more parameter values defining an expected temperature range may be indicated to and stored at a memory system, where the memory system may define a safe temperature range and one or more additional temperature ranges using the one or more parameter values. After entering the safe temperature range, the memory system may refresh one or more memory cells of one or more memory devices for which write operations were performed outside of the safe temperature range. By defining safe temperatures for operation using an expected operating range, the memory system may reduce a quantity and frequency of refresh operations and may increase a performance and quality of service (QOS), while reducing latency in operations and communications. Further, endurance and device lifetime may be increased by reducing a quantity of refresh operations.

### CROSS REFERENCE

The present Application for Patent claims priority to U.S. patent application Ser. No. 63/677,331 by Minopoli et al., entitled “CROSS-TEMPERATURE RANGE MANAGEMENT IN MEMORY SYSTEMS,” filed Jul. 30, 2024, which is assigned to the assignee hereof, and which is expressly incorporated by reference in its entirety herein.

### TECHNICAL FIELD

The following relates to one or more systems for memory, including cross-temperature range management in memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports cross-temperature range management in memory systems in accordance with examples as disclosed herein.

FIGS. 2A, 2B, and 2C show examples of temperature range diagrams that support cross-temperature range management in memory systems in accordance with examples as disclosed herein.

FIG. 3 shows an example of a flow diagram that supports cross-temperature range management in memory systems in accordance with examples as disclosed herein.

FIG. 4 shows a block diagram of a memory system that supports cross-temperature range management in memory systems in accordance with examples as disclosed herein.

FIG. 5 shows a flowchart illustrating a method or methods that support cross-temperature range management in memory systems in accordance with examples as disclosed herein.

### DETAILED DESCRIPTION

Some memory systems, including not-AND (NAND) memory systems, may operate within one or more supported temperature ranges. For example, a memory system may define a full temperature range (e.g., a full cross-temperature range, or X-Temp range) that may represent a maximum range of temperatures supported by one or more devices of that memory system and within which the memory system may be operable. Further, the memory system may define a subset of the full temperature range, such as a safe temperature range (e.g., a safe zone), within which the memory system may safely operate. That is, a safe temperature range may define a minimum span between two temperatures within the full supported temperature range where a memory system may store data with a defined level of reliability. If data is written outside of the safe temperature range, the memory system may perform one or more refresh operations after entering the safe temperature range to ensure that data is stored reliably. Some applications may utilize an extended range capability, such as electronic equipment that operates across multiple geographical regions and which may be subject to a full temperature range supported by the memory system, and so may implement a safe temperature range that is determined using the full supported temperature range. As such, many media scan algorithms and data reliability containment procedures may be performed with an assumption that a memory system is to support a full cross-temperature (e.g., X-Temp) range. However, many memory systems may operate within a range smaller than a full supported temperature range, but may perform additional refresh operations due to the defined safe temperature range corresponding to the larger, full temperature range. Such additional refresh operations may result in lower performance and increased latency in operations, while reducing a lifetime of the memory system.

Techniques described herein may support providing (e.g., signaling to) a memory system of an expected temperature operating range (also referred to as an expected temperature range), and determining a safe temperature range using the expected temperature range to enable full cross-temperature support. In some examples, one or more parameter values defining an expected temperature range may be indicated to and stored at the memory system, where the memory system may define data reliability and cross-temperature management algorithms (e.g., models) according to the expected temperature range. For example, after entering (e.g., transitioning to) a safe temperature range determined using the expected temperature range, the memory system may refresh one or more memory cells of one or more memory devices for which write operations were performed outside of the safe temperature range. By defining safe temperatures for operation (e.g., for reliably writing to memory cells) using an expected temperature operating range, the memory system may reduce a quantity (e.g., number of) and frequency (e.g., rate, recurrence) of refresh operations by removing unnecessary refreshes, increasing a performance and quality of service (QOS), while reducing latency in operations and communications. Further, endurance and device lifetime (e.g., terabytes written (TBW)) may be improved by removing refresh operations, as a reduced quantity of refresh operations may result in less write operations and program-erase (PE) cycles of memory cells of one or more memory devices.

In addition to applicability in memory systems as described herein, techniques for cross-temperature range management may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing a quantity of refresh operations, which may decrease processing and latency times, improve response times, or otherwise improve user experience and QoS, among other benefits.

In addition to applicability in memory systems as described herein, techniques for cross-temperature range management may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may reduce a quantity of refresh operations performed at one or more memory devices, which may result in lowered production emissions and reduced electronic waste by extending a life of electronic devices, and thereby reducing added manufacturing, among other benefits.

Features of the disclosure are illustrated and described in the context of systems, devices, and circuits. Features of the disclosure are further illustrated and described in the context of temperature range diagrams, flow diagrams, block diagrams, and flowcharts.

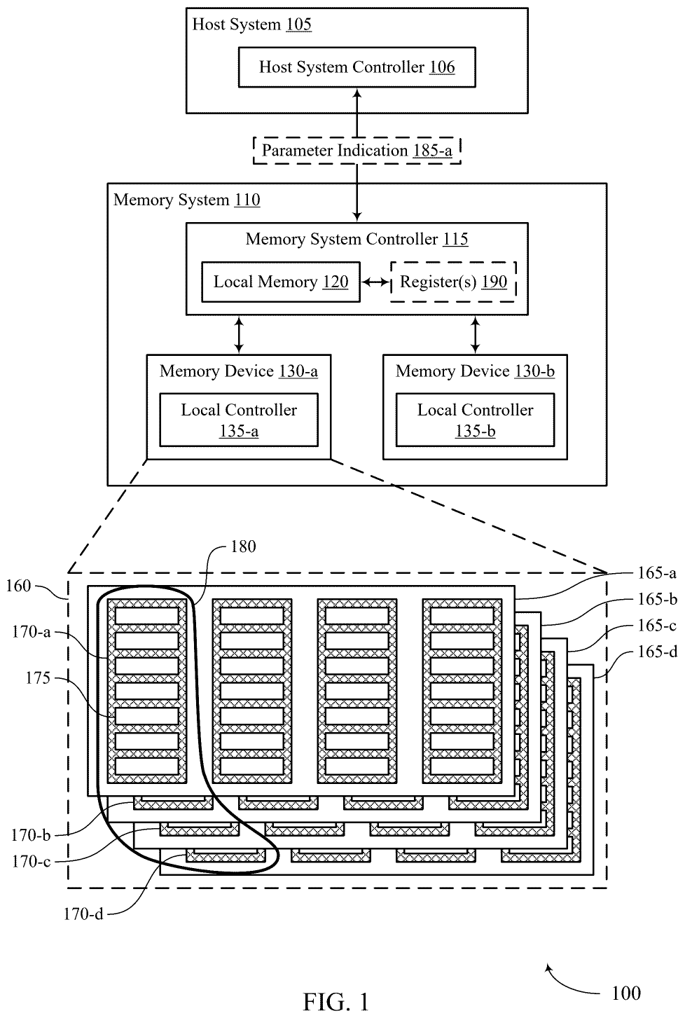

FIG. 1 shows an example of a system 100 that supports cross-temperature range management in memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may support notifying a memory system of an expected temperature operating range, and determining a safe temperature range using the expected temperature range in place of guaranteeing full cross-temperature support. For example, the host system 105 may notify the memory system 110 (e.g., an mNAND device) of an expected temperature operating range by transmitting a parameter indication 185, such as a parameter indication 185-a. The parameter indication 185-a may indicate a set of one or more parameter values that define an expected temperature range for operation of the memory system 110. In some examples, the memory system 110 may store the one or more parameter values to one or more registers 190 of the memory system 110 (e.g., in registers of local memory 120, in registers of one or more memory devices 130). Using the one or more parameter values, the memory system 110 may define data reliability and cross-temperature management algorithms according to the expected temperature range. For example, after entering a safe temperature range determined using the expected temperature range, the memory system 110 may refresh one or more memory cells of one or more memory devices 130 for which write operations were previously performed outside of the safe temperature range.

The memory system 110, or one or more memory devices 130, may determine the safe temperature range based on the temperature operating range provided by the host system 105 and the temperature range capability supported by the memory system 110. In some cases, data refresh operations for data written in hot or cold temperature ranges are necessary if the operating temperature range declared by the host system 105 exceeds (e.g., greater than) that supported by the memory system 110 (e.g., one or more memory devices 130).

The system 100 may include any quantity of non-transitory computer readable media that support cross-temperature range management in memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

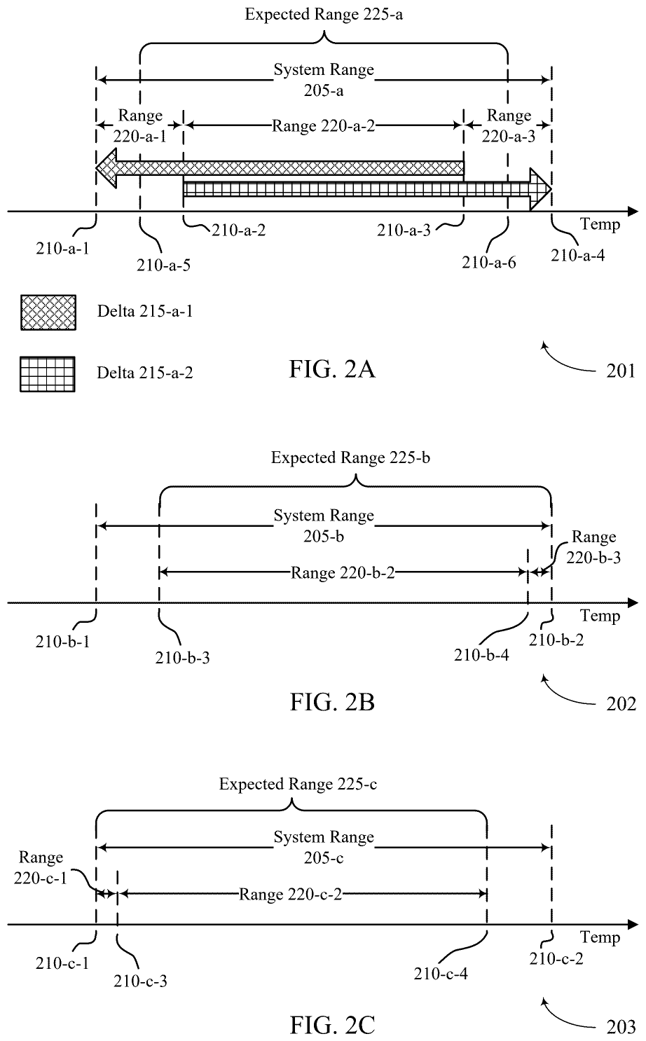

FIGS. 2A, 2B, and 2C show examples of temperature range diagrams 201, 202, and 203 that support cross-temperature range management in memory systems in accordance with examples as disclosed herein. One or more aspects of the temperature range diagrams 201, 202, and 203 may be implemented by one or more aspects of the system 100. For example, the temperature range diagrams 201, 202, and 203 may illustrate different system ranges 205 and ranges 220 of temperatures 210 (e.g., ° C., ° F., Kelvins (K)) supported for one or more access operations at a memory system 110 in communication with a host system 105. In some examples, the temperature range diagrams 201, 202, and 203 may support definition of ranges for operation using expected temperature ranges as described herein.

In some examples, as illustrated in FIG. 2A, a memory system 110 (e.g., a NAND system, an mNAND system) may support a system range 205 that may correspond to a capability of the memory system 110 (e.g., NAND capability). In some examples, the memory system 110 may support different deltas 215, which may represent supported changes in temperature for safe operation within which the memory system 110 may store and read data with a defined level of reliability. For example, a delta 215-a may be a maximum temperature difference, or span, between a temperature at which data is written, and a temperature at which the data may be reliably read. In some examples, the memory system 110 may support a hot-to-cold cross temperature capability, H2C (e.g., H2C_{NAND}), corresponding to a delta 215. For example, a delta 215-a-1 may range down to a temperature 210-a-1 for a write performed at a temperature 210-a-3. The memory system 110 may also support a cold-to-hot cross-temperature capability, or C2H (e.g., C2H_{NAND}), such as a delta 215-a-2. In some examples, the delta 215-a-1 may be equal to the delta 215-a-2, or the two values may be defined with different values.

The memory system 110 may support a full temperature range, such as a supported system range 205-a (e.g., system temperature range), defined by a lower temperature boundary (e.g., lower limit) at the temperature 210-a-1 and an upper temperature boundary at a temperature 210-a-4. In some examples, a safe temperature range may be a range of temperatures in the system range 205-a within which any data that is written may also be reliably read. For example, a value of a delta 215 may define the deltas 215-a-1 and 215-a-2 to extend from the boundaries of the system range 205-a, where a safe temperature range may be a range 220-a-2 where the deltas 215-a-1 and 215-a-2 overlap. For example, memory cells storing data written outside of the range 220-a-2, such as written in a range 220-a-1 (e.g., a cold temperature range, or cold zone) or within a range 220-a-3 (e.g., a hot temperature range, or hot zone), may be refreshed after the memory system 110 re-enters the safe range 220-a-2. Refresh operations may involve reading data and copying data into another memory block, and may in some cases reduce a performance of the memory system 110, as firmware of the memory system 110 may cause one or more memory cells to be unavailable to refresh data while slowing one or more user requests. Further, refresh operations may reduce an endurance of the memory system 110, as each refresh operation may involve one or more PE cycles, reducing an overall lifetime of one or more devices. For example, a terabytes written (TBW) of a device, or a total quantity of terabytes (or other storage metric) that may be written over a lifetime of the device, may be reduced or used by additional PE cycles caused by refresh operations.

Some applications may support an extended temperature range capability. For example, electronic equipment used in a variety of geographical locations may be subject to the full system range 205-a. In order to guarantee that data is valid and reliable in an extended temperature range, the memory system 110 (e.g., via mNAND firmware, via one or more controllers) may monitor data which is likely to be accessed in the extended range (e.g., beyond a defined delta 215) and may plan (e.g., schedule) refresh operations accordingly if the temperature range allows (e.g., if a current temperature is in a safe range). However, although some devices may operate within a smaller temperature range than the system range 205-a, operations (e.g., media scan algorithms, data reliability containment procedures) may be performed using safe zones, hot zones, and cold zones defined using the system range 205-a, resulting in unnecessary refresh operations being performed. For example, the memory system 110 may operate in a hotter climate ranging from the temperature 210-a-2 to the temperature 210-a-4, which may satisfy the delta 215-a-2 supported by the device, but may perform refresh operations for any data written above the temperature 210-a-3 regardless. Such additional refresh operations may thus reduce a performance and lifetime of one or more devices.

As described herein, a memory system 110 (e.g., an mNAND system, a NAND system) may support defining one or more ranges, such as the range 220-a-1, using an expected range 225 (e.g., an expected temperature range) that may indicate likely or expected temperatures for operations. For example, many systems and applications may know (e.g., be configured, signaled) in advance a maximum temperature operating range for a practical application. For example, a host system 105 may notify a memory system 110 of a set of one or more parameter values (e.g., a maximum value and a minimum value) that may indicate an excepted temperature range 225, which may be the same as, less than, or span different temperatures than, the system range 205-a. For example, in a balanced application (e.g., a mobile phone, a user device in a medical or office environment), a span of an expected range of 225-a may be from a temperature 210-a-5 to a temperature 210-a-6. Other ranges may also be considered. For example, FIG. 2B may illustrate a higher temperature application (e.g., a vehicle in a hot climate) with a supported system range 205-b between temperatures 210-b-1 and 210-b-2, where an expected range 225-b-1 may be between a temperature 210-b-3 and the temperature 210-b-2. In another example, FIG. 2C may illustrate a lower temperature application (e.g., an outdoor device in a cold climate) with a supported system range 205-c between temperatures 210-c-1 and 210-c-2, where an expected range 225-c-1 may be between the temperature 210-c-1 and a temperature 210-c-4.

In some examples, an expected range 225 (e.g., an expected temperature operating range) may be declared using one or more commands or parameters to enable improved data refresh policy behavior for an expected range. For example, a memory system 110 may define two descriptors (e.g., parameters) that may declare an expected operating temperature range, such as a maximum operating temperature (e.g., the temperature 210-a-6, bMinOperatingTemperatur) and a minimum operating temperature (e.g., the temperature 210-a-5, bMaxOperatingTemperature). In some examples, the descriptors may represent register files or parameters that may define a maximum and minimum temperature expected by an overall system or application, and may be represented by one or more bits or bytes of data. In some cases, parameter values for the descriptors may be declared by the host system 105 via one or more commands (e.g., via parameter indications 185), or by the memory system 110.

In some examples, the two descriptors may be declared by indicating, or storing, parameter values (e.g., minimum and maximum temperature values) during a provisioning time during which resources of one or more memory devices are provisioned for use (e.g., during manufacture, during testing). In such a case, the parameter values may be stored in registers, and may become read-only after the provisioning time is finished. Additionally, or alternatively, the descriptors may be made available for reading or to be declared (e.g., indicated, written using a Mode Register Write (MRW) command) during a lifetime of the memory system 110 (e.g., on the fly after provisioning). Further, the descriptors may be updated at any time using a vendor-unique (VU) command (VU command, vendor-specific command) declaring an expected temperature range. In some examples, regardless of a command type, setting descriptors may be non-volatile (e.g., saved in non-volatile registers and maintained across power cycles).

In some examples, using a defined expected range 225, a memory system 110 may redefine (e.g., update, modify, adjust) one or more refresh policies (e.g., hot-range and cold-range refresh policies). For example, a declared expected range 225 may have a declared temperature range delta equal to a difference between an expected maximum temperature value and an expected minimum temperature value (e.g., delta=max−min). If the declared temperature range delta is within a capability of the memory system 110, for example, is less than or equal to a supported delta 215 for reliable writes and reads, the memory system 110 may disable (e.g., deactivate) data refresh due to cross-temperature events. For example, if the temperature values 210-a-2 and 210-a-3 were declared to define an expected range 225 equal to the range 220-a-2, the memory system 110 may disable data refresh for cross-temperature applications as memory cells may remain within a safe temperature range. By way of another example, if the declared temperature range delta is set to a full temperature extent, such as in a full range application equal to the system range 205-a (e.g., for an airplane information system that travels between different climates), the memory system 110 may enable (e.g., activate) data refresh due to cross-temperature events using defined temperature thresholds for the full system range 205-a.

By way of another example, if the declared expected temperature range delta is beyond a capability of the memory system 110, for example, is greater than a supported delta 215 (e.g., satisfies a threshold delta 215) but lower than a full extent of a system range 205, the memory system 110 may adjust temperature thresholds for cross-temperature management. In such a case, thresholds may be adjusted to trigger data refresh for temperature ranges in which refresh would mitigate low reliability reads while avoiding unneeded refreshes in ranges that would result in reliable reads. For example, in FIG. 2B, a range 220-b-2 may be defined as a safe zone, and a range 220-b-3 between temperatures 210-b-4 (e.g., an upper temperature boundary value of the safe zone) and temperature 210-b-2 (e.g., an expected maximum temperature) may be defined as a hot zone using the expected range 225-b. Data written above the temperature 210-b-4 (e.g., within the range 220-b-3 or above), as well as data written below the temperature 210-b-3 (e.g., below the range 220-b-2) may be refreshed. Similarly, in FIG. 2C, a range 220-c-2 may be defined along with a range 220-c-1 between the temperature 210-c-1 (e.g., a minimum expected temperature) and a temperature 210-c-3 (e.g., a lower temperature boundary value of the safe zone) using the expected range 225-c. In both examples of FIGS. 2B and 2C, a safe zone is determined using a delta and the expected range 225-b or 225-c, instead of the full range 205-b or 205-c, resulting in a span of a safe zone increasing and subsequently reducing a quantity of refreshes. In some examples, such ranges 220 (e.g., hot zones, cold zones, and safe zones) may be determined by a memory system 110 (or memory device) using a declared expected range 225 received from a host system 105. Additionally, or alternatively, the ranges 220 may be indicated along with an expected range 225. Other ranges may also be determined. For example, a portion of any of a safe zone, cold zone, or hot zone may overlap with an expected range, while another portion may exceed the expected range. Further, an expected range may in some cases exceed a boundary of a system range 205, and ranges 220 may be selected within the system range 205.

In some examples, the memory system 110 may support a parachute policy which may define updating one or more parameter values or register values in response to exceeding one or more defined ranges 220. For example, a memory system 110 may monitor and measure one or more temperature ranges during operation, may determine that an operating range set by a system (e.g., an expected range 225 that is indicated and stored, related ranges 220, or previously defined ranges 220) is exceeded, and may autonomously ignore one or more system settings, and overwrite parameters (e.g., descriptors in registers) using values corresponding to one or more new measured temperature ranges.

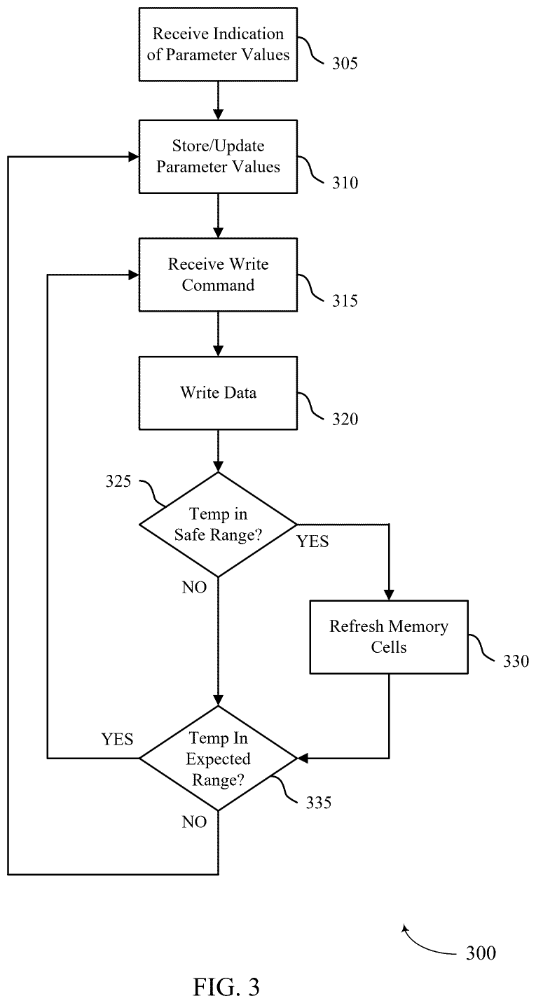

FIG. 3 shows an example of a flow diagram 300 that supports cross-temperature range management in memory systems in accordance with examples as disclosed herein. One or more aspects of the flow diagram 300 may be implemented by one or more aspects of the system 100 or the temperature range diagrams 201, 202, and 203. For example, the flow diagram 300 may illustrate a decision process for indicating one or more parameter values to define an expected range (e.g., an expected range 225), performing one or more refresh operations using the expected range, and updating that range. In the following description of the flow diagram 300, the operations may be performed (e.g., reported or provided) in a different order than the order shown, and some operations also may be omitted from the flow diagram 300, or other operations may be added to the flow diagram 300. Further, although some operations or signaling may be shown to occur at different times for discussion purposes, these operations may actually occur at the same time or at least partially concurrently.

At 305, an indication is received. For example, a memory system 110 may receive an indication of a set of one or more parameter values that defines a first temperature range (e.g., an expected range 225) associated with operation of the memory system 110. In some examples, the memory system 110 may store the set of one or more parameter values to one or more registers at 310 (e.g., one or more registers 190). In some examples, the indication may be received, or the one or more parameters may be stored, during a first time duration associated with provisioning one or more resources, or during a second time duration associated with operation of the memory system, or at any other time (e.g., in response to a VU command).

At 315, one or more write commands may be received. For example, the memory system 110 may receive one or more write commands indicating to write data to one or more memory cells of the memory system, and may write the data to the one or more memory cells of the memory system at 320 in accordance with the write command. In some examples, the memory system 110 may store an indication to refresh the one or more memory cells in response to a corresponding temperature value exceeding a second temperature range (e.g., a safe zone, a safe temperature range), which may be done in accordance with monitoring a current temperature of the memory system 110.

At 325, a determination regarding a temperature value is made. For example, the memory system 110 may determine whether the temperature value (e.g., by monitoring a current temperature) of the memory system is within the second temperature range (e.g., a safe zone), where a portion of the second temperature range may be within the first temperature range. In some examples, the memory system 110 may proceed to 330 to refresh the one or more memory cells in response to the temperature value of the memory system being within the portion of the second temperature range, and in response to data written to the one or more memory cells at the corresponding temperature value exceeding the second temperature range. For example, the refreshing of the one or more memory cells may be in response to storing the indication of exceeding the second temperature range. The memory system 110 may proceed to 335 after refreshing the one or more memory cells, or if the temperature is not within the second temperature range.

At 335, a determination regarding a temperature value is made. For example, the memory system 110 may determine whether the temperature value of the memory system exceeds the first temperature range (e.g., expected range 225) and is within a system temperature range (e.g., a system range 205) supported by the memory system 110. In some examples, the memory system 110 may proceed to 315 to receive one or more additional write commands if the temperature is within the first temperature range. Otherwise, the memory system 110 may proceed to 310 to update the second temperature range by adjusting the stored set of one or more parameter values in response to the temperature value of the memory system exceeding the first temperature range and being within the system temperature range.

Aspects of the flow diagram 300 may be implemented by one or more controllers, among other components. Additionally, or alternatively, aspects of the flow diagram 300 may be implemented as instructions stored in one or more memories (e.g., firmware stored in one or more memories coupled with one or more controllers). For example, the instructions, when executed by one or more controllers, may cause the one or more controllers (or a device or a system) to perform the operations of the flow diagram 300.

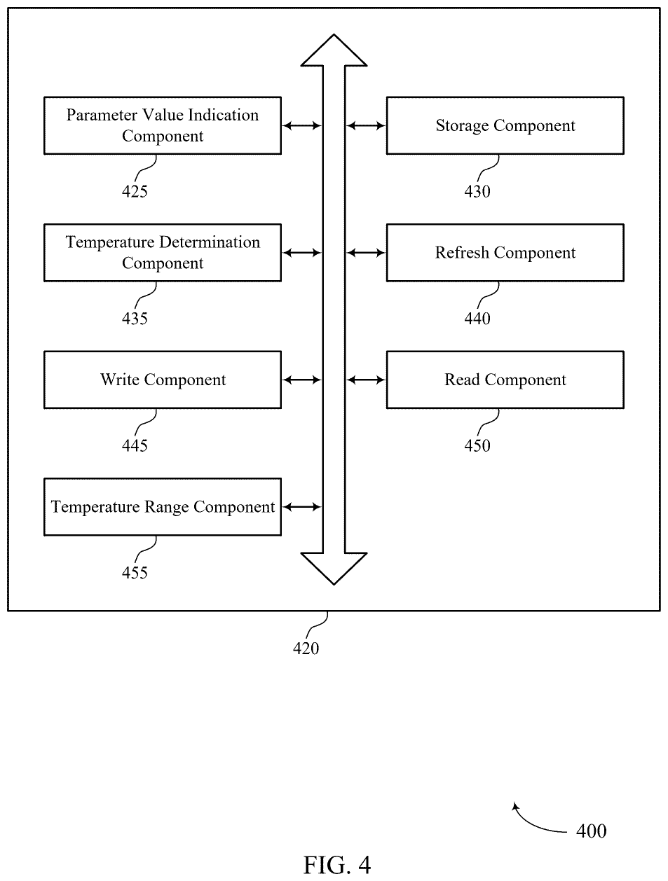

FIG. 4 shows a block diagram 400 of a memory system 420 that supports cross-temperature range management in memory systems in accordance with examples as disclosed herein. The memory system 420 may be an example of aspects of a memory system as described with reference to FIGS. 1 through 3. The memory system 420, or various components thereof, may be an example of means for performing various aspects of cross-temperature range management in memory systems as described herein. For example, the memory system 420 may include a parameter value indication component 425, a storage component 430, a temperature determination component 435, a refresh component 440, a write component 445, a read component 450, a temperature range component 455, or any combination thereof. Each of these components, or components of subcomponents thereof (e.g., one or more processors, one or more memories), may communicate, directly or indirectly, with one another (e.g., via one or more buses).

The parameter value indication component 425 may be configured as or otherwise support a means for receiving an indication of a set of one or more parameter values that defines a first temperature range associated with operation of the memory system. The storage component 430 may be configured as or otherwise support a means for storing the set of one or more parameter values to one or more registers of the memory system. The temperature determination component 435 may be configured as or otherwise support a means for determining whether a temperature value of the memory system is within a second temperature range, where a portion of the second temperature range is within the first temperature range. The refresh component 440 may be configured as or otherwise support a means for refreshing one or more memory cells in response to the temperature value of the memory system being within the portion of the second temperature range and in response to data written to the one or more memory cells at a corresponding temperature value that exceeds the second temperature range.

In some examples, the write component 445 may be configured as or otherwise support a means for receiving a write command that indicates to write data to the one or more memory cells of the memory system. In some examples, the write component 445 may be configured as or otherwise support a means for writing the data to the one or more memory cells of the memory system in accordance with the write command. In some examples, the storage component 430 may be configured as or otherwise support a means for storing an indication to refresh the one or more memory cells in response to the corresponding temperature value exceeding the second temperature range, where refreshing the one or more memory cells is in response to storing the indication.

In some examples, the temperature determination component 435 may be configured as or otherwise support a means for determining whether the temperature value of the memory system exceeds the first temperature range and is within a system temperature range supported by the memory system. In some examples, the storage component 430 may be configured as or otherwise support a means for updating the second temperature range by adjusting the stored set of one or more parameter values in response to the temperature value of the memory system exceeding the first temperature range and being within the system temperature range.

In some examples, the temperature determination component 435 may be configured as or otherwise support a means for monitoring the temperature value of the memory system, where determining whether the temperature value of the memory system is within the second temperature range is in accordance with the monitoring.

In some examples, the set of one or more parameter values include a first expected temperature value associated with operation of the memory system and a second expected temperature value associated with operation of the memory system, the set of one or more parameter values is provided during a provisioning time, a lifetime of the memory system, or in response to a vendor-unique command and irrespective of time, the second expected temperature value is lower than the first expected temperature value, and the first expected temperature value and the second expected temperature value define the first temperature range.

In some examples, the set of one or more parameter values is received during a first time duration associated with provisioning one or more resources, where the first expected temperature value and the second expected temperature value are stored to the one or more registers during the first time duration; or the set of one or more parameter values is received during a second time duration associated with operation of the memory system, where the first expected temperature value and the second expected temperature value are stored to the one or more registers during the second time duration.

In some examples, the temperature range component 455 may be configured as or otherwise support a means for determining the second temperature range in accordance with the set of one or more parameter values. In some examples, the temperature range component 455 may be configured as or otherwise support a means for determining a hot temperature range, where a span of the hot temperature range is between an upper temperature boundary value of the second temperature range and the first expected temperature value associated with operation of the memory system. In some examples, the temperature range component 455 may be configured as or otherwise support a means for determining a cold temperature range, where a span of the cold temperature range is between a lower temperature boundary value of the second temperature range and the second expected temperature value associated with operation of the memory system.

In some examples, the temperature range component 455 may be configured as or otherwise support a means for determining whether a difference between the first expected temperature value and the second expected temperature value satisfies a threshold difference and whether the first temperature range is within a system temperature range supported by the memory system. In some examples, the storage component 430 may be configured as or otherwise support a means for updating the second temperature range by adjusting the stored set of one or more parameter values in response to determining that the difference satisfies the threshold difference and that the first temperature range is within the system temperature range.

In some examples, to support refreshing the one or more memory cells, the read component 450 may be configured as or otherwise support a means for reading data from a first block of memory cells including the one or more memory cells. In some examples, to support refreshing the one or more memory cells, the write component 445 may be configured as or otherwise support a means for writing the data to a second block of memory cells including one or more second memory cells.

In some examples, the indication includes a VU command.

In some examples, the first temperature range includes a full temperature range supported by the memory system.

In some examples, a portion of the first temperature range is less than a span of a full temperature range supported by the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

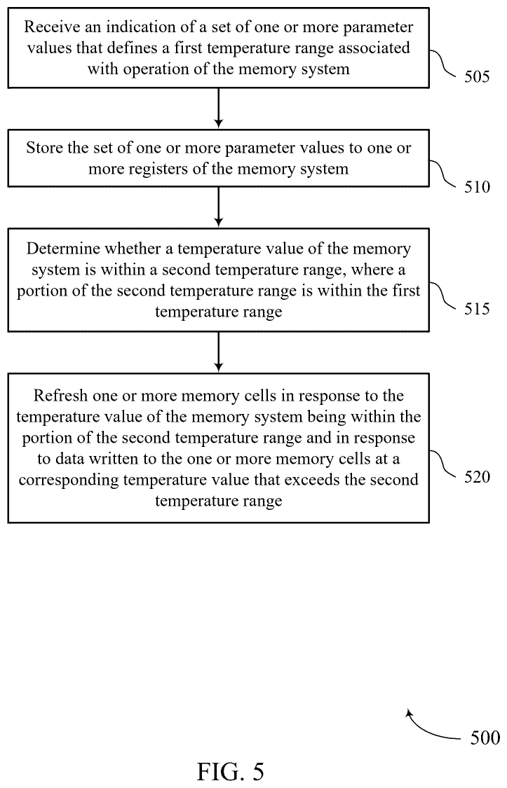

FIG. 5 shows a flowchart illustrating a method 500 that supports cross-temperature range management in memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving an indication of a set of one or more parameter values that defines a first temperature range associated with operation of the memory system. In some examples, aspects of the operations of 505 may be performed by a parameter value indication component 425 as described with reference to FIG. 4.

At 510, the method may include storing the set of one or more parameter values to one or more registers of the memory system. In some examples, aspects of the operations of 510 may be performed by a storage component 430 as described with reference to FIG. 4.

At 515, the method may include determining whether a temperature value of the memory system is within a second temperature range, where a portion of the second temperature range is within the first temperature range. In some examples, aspects of the operations of 515 may be performed by a temperature determination component 435 as described with reference to FIG. 4.

At 520, the method may include refreshing one or more memory cells in response to the temperature value of the memory system being within the portion of the second temperature range and in response to data written to the one or more memory cells at a corresponding temperature value that exceeds the second temperature range. In some examples, aspects of the operations of 520 may be performed by a refresh component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a set of one or more parameter values that defines a first temperature range (e.g., an expected range 225) associated with operation of the memory system; storing the set of one or more parameter values to one or more registers of the memory system; determining whether a temperature value of the memory system is within a second temperature range (e.g., a safe range), where a portion of the second temperature range is within the first temperature range; and refreshing one or more memory cells in response to the temperature value of the memory system being within the portion of the second temperature range and in response to data written to the one or more memory cells at a corresponding temperature value that exceeds the second temperature range.

Aspect 2: The method, apparatus, or non-transitory computer-readable medium of aspect 1, further including operations, features, circuitry, logic, means, or instructions, or any combination thereof for receiving a write command that indicates to write data to the one or more memory cells of the memory system; writing the data to the one or more memory cells of the memory system in accordance with the write command; and storing an indication to refresh the one or more memory cells in response to the corresponding temperature value exceeding the second temperature range, where refreshing the one or more memory cells is in response to storing the indication.

Aspect 3: The method, apparatus, or non-transitory computer-readable medium of any of aspects 1 through 2, further including operations, features, circuitry, logic, means, or instructions, or any combination thereof for determining whether the temperature value of the memory system exceeds the first temperature range and is within a system temperature range supported by the memory system and updating the second temperature range by adjusting the stored set of one or more parameter values in response to the temperature value of the memory system exceeding the first temperature range and being within the system temperature range.

Aspect 4: The method, apparatus, or non-transitory computer-readable medium of any of aspects 1 through 3, further including operations, features, circuitry, logic, means, or instructions, or any combination thereof for monitoring the temperature value of the memory system, where determining whether the temperature value of the memory system is within the second temperature range is in accordance with the monitoring.

Aspect 5: The method, apparatus, or non-transitory computer-readable medium of any of aspects 1 through 4, where the set of one or more parameter values include a first expected temperature value associated with operation of the memory system (e.g., a minimum temperature) and a second expected temperature value associated with operation of the memory system (e.g., a maximum temperature), the set of one or more parameter values is provided (e.g., configured, received) during a provisioning time, a lifetime of the memory system, or in response to a vendor-unique command and irrespective of time, the second expected temperature value is lower than the first expected temperature value, and the first expected temperature value and the second expected temperature value define the first temperature range.

Aspect 6: The method, apparatus, or non-transitory computer-readable medium of aspect 5, where the set of one or more parameter values is received during a first time duration associated with provisioning one or more resources (e.g., provisioning time), where the first expected temperature value and the second expected temperature value are stored to the one or more registers during the first time duration; or the set of one or more parameter values is received during a second time duration associated with operation of the memory system (e.g., during a lifetime of the memory system), where the first expected temperature value and the second expected temperature value are stored to the one or more registers during the second time duration.

Aspect 7: The method, apparatus, or non-transitory computer-readable medium of any of aspects 5 through 6, further including operations, features, circuitry, logic, means, or instructions, or any combination thereof for determining the second temperature range in accordance with the set of one or more parameter values; determining a hot temperature range (e.g., a hot zone), where a span of the hot temperature range is between an upper temperature boundary value of the second temperature range and the first expected temperature value associated with operation of the memory system; and determining a cold temperature range (e.g., a cold zone), where a span of the cold temperature range is between a lower temperature boundary value of the second temperature range and the second expected temperature value associated with operation of the memory system.

Aspect 8: The method, apparatus, or non-transitory computer-readable medium of any of aspects 5 through 7, further including operations, features, circuitry, logic, means, or instructions, or any combination thereof for determining whether a difference between the first expected temperature value and the second expected temperature value satisfies a threshold difference (e.g., is greater than a supported delta 215) and whether the first temperature range is within a system temperature range (e.g., a system range 205) supported by the memory system and updating the second temperature range by adjusting the stored set of one or more parameter values in response to determining that the difference satisfies the threshold difference and that the first temperature range is within the system temperature range.

Aspect 9: The method, apparatus, or non-transitory computer-readable medium of any of aspects 1 through 8, where refreshing the one or more memory cells includes operations, features, circuitry, logic, means, or instructions, or any combination thereof for reading data from a first block of memory cells including the one or more memory cells and writing the data to a second block of memory cells including one or more second memory cells.

Aspect 10: The method, apparatus, or non-transitory computer-readable medium of any of aspects 1 through 9, where the indication includes a VU command.

Aspect 11: The method, apparatus, or non-transitory computer-readable medium of any of aspects 1 through 10, where the first temperature range includes a full temperature range supported by the memory system (e.g., expected range 225 is indicated as a full system range 205).

Aspect 12: The method, apparatus, or non-transitory computer-readable medium of any of aspects 1 through 11, where a portion of the first temperature range is less than a span of a full temperature range supported by the memory system (e.g., expected range 225 is indicated as smaller than a full system range 205).

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit corresponding to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a set of one or more parameter values that defines a first temperature range associated with operation of the memory system;
store the set of one or more parameter values to one or more registers of the memory system;
determine whether a temperature value of the memory system is within a second temperature range, wherein a portion of the second temperature range is within the first temperature range; and
refresh one or more memory cells in response to the temperature value of the memory system being within the portion of the second temperature range and in response to data written to the one or more memory cells at a corresponding temperature value that exceeds the second temperature range.

2. The memory system of claim 1, wherein the processing circuitry is further configured to cause the memory system to:
receive a write command that indicates to write data to the one or more memory cells of the memory system;
write the data to the one or more memory cells of the memory system in accordance with the write command; and
store an indication to refresh the one or more memory cells in response to the corresponding temperature value exceeding the second temperature range, wherein refreshing the one or more memory cells is in response to storing the indication.

3. The memory system of claim 1, wherein the processing circuitry is further configured to cause the memory system to:
determine whether the temperature value of the memory system exceeds the first temperature range and is within a system temperature range supported by the memory system; and
update the second temperature range by adjusting the stored set of one or more parameter values in response to the temperature value of the memory system exceeding the first temperature range and being within the system temperature range.

4. The memory system of claim 1, wherein the processing circuitry is further configured to cause the memory system to:
monitor the temperature value of the memory system, wherein determining whether the temperature value of the memory system is within the second temperature range is in accordance with the monitoring.

5. The memory system of claim 1, wherein:
the set of one or more parameter values comprise a first expected temperature value associated with operation of the memory system and a second expected temperature value associated with operation of the memory system, the set of one or more parameter values is provided during a provisioning time, a lifetime of the memory system, or in response to a vendor-unique command and irrespective of time,
the second expected temperature value is lower than the first expected temperature value, and
the first expected temperature value and the second expected temperature value define the first temperature range.

6. The memory system of claim 5, wherein:
the set of one or more parameter values is received during a first time duration associated with provisioning one or more resources, wherein the first expected temperature value and the second expected temperature value are stored to the one or more registers during the first time duration; or
the set of one or more parameter values is received during a second time duration associated with operation of the memory system, wherein the first expected temperature value and the second expected temperature value are stored to the one or more registers during the second time duration.

7. The memory system of claim 5, wherein the processing circuitry is further configured to cause the memory system to:
determine the second temperature range in accordance with the set of one or more parameter values;
determine a hot temperature range, wherein a span of the hot temperature range is between an upper temperature boundary value of the second temperature range and the first expected temperature value associated with operation of the memory system; and
determine a cold temperature range, wherein a span of the cold temperature range is between a lower temperature boundary value of the second temperature range and the second expected temperature value associated with operation of the memory system.

8. The memory system of claim 5, wherein the processing circuitry is further configured to cause the memory system to:
determine whether a difference between the first expected temperature value and the second expected temperature value satisfies a threshold difference and whether the first temperature range is within a system temperature range supported by the memory system; and
update the second temperature range by adjusting the stored set of one or more parameter values in response to determining that the difference satisfies the threshold difference and that the first temperature range is within the system temperature range.

9. The memory system of claim 1, wherein refreshing the one or more memory cells comprises the processing circuitry configured to cause the memory system to:
read data from a first block of memory cells comprising the one or more memory cells; and
write the data to a second block of memory cells comprising one or more second memory cells.

10. The memory system of claim 1, wherein the indication comprises a vendor-unique command.

11. The memory system of claim 1, wherein the first temperature range comprises a full temperature range supported by the memory system.

12. The memory system of claim 1, wherein a portion of the first temperature range is less than a span of a full temperature range supported by the memory system.

13. A non-transitory computer-readable medium storing code comprising instructions which, when executed by processing circuitry of a memory system, cause the memory system to:
receive an indication of a set of one or more parameter values that defines a first temperature range associated with operation of the memory system;
store the set of one or more parameter values to one or more registers of the memory system;
determine whether a temperature value of the memory system is within a second temperature range, wherein a portion of the second temperature range is within the first temperature range; and
refresh one or more memory cells in response to the temperature value of the memory system being within the portion of the second temperature range and in response to data written to the one or more memory cells at a corresponding temperature value that exceeds the second temperature range.

14. The non-transitory computer-readable medium of claim 13, wherein the instructions, when executed by the processing circuitry of the memory system, further cause the memory system to:
receive a write command that indicates to write data to the one or more memory cells of the memory system;
write the data to the one or more memory cells of the memory system in accordance with the write command; and
store an indication to refresh the one or more memory cells in response to the corresponding temperature value exceeding the second temperature range, wherein refreshing the one or more memory cells is in response to storing the indication.

15. The non-transitory computer-readable medium of claim 13, wherein the instructions, when executed by the processing circuitry of the memory system, further cause the memory system to:
determine whether the temperature value of the memory system exceeds the first temperature range and is within a system temperature range supported by the memory system; and
update the second temperature range by adjusting the stored set of one or more parameter values in response to the temperature value of the memory system exceeding the first temperature range and being within the system temperature range.

16. The non-transitory computer-readable medium of claim 13, wherein the instructions, when executed by the processing circuitry of the memory system, further cause the memory system to:
monitor the temperature value of the memory system, wherein determining whether the temperature value of the memory system is within the second temperature range is in accordance with the monitoring.

17. The non-transitory computer-readable medium of claim 13, wherein:
the set of one or more parameter values comprise a first expected temperature value associated with operation of the memory system and a second expected temperature value associated with operation of the memory system, the set of one or more parameter values is provided during a provisioning time, a lifetime of the memory system, or in response to a vendor-unique command and irrespective of time,
the second expected temperature value is lower than the first expected temperature value, and
the first expected temperature value and the second expected temperature value define the first temperature range.

18. The non-transitory computer-readable medium of claim 17, wherein:
the set of one or more parameter values is received during a first time duration associated with provisioning one or more resources, wherein the first expected temperature value and the second expected temperature value are stored to the one or more registers during the first time duration; or
the set of one or more parameter values is received during a second time duration associated with operation of the memory system, wherein the first expected temperature value and the second expected temperature value are stored to the one or more registers during the second time duration.

19. The non-transitory computer-readable medium of claim 17, wherein the instructions, when executed by the processing circuitry of the memory system, further cause the memory system to:
determine the second temperature range in accordance with the set of one or more parameter values;
determine a hot temperature range, wherein a span of the hot temperature range is between an upper temperature boundary value of the second temperature range and the first expected temperature value associated with operation of the memory system; and
determine a cold temperature range, wherein a span of the cold temperature range is between a lower temperature boundary value of the second temperature range and the second expected temperature value associated with operation of the memory system.

20. The non-transitory computer-readable medium of claim 17, wherein the instructions, when executed by the processing circuitry of the memory system, further cause the memory system to:
determine whether a difference between the first expected temperature value and the second expected temperature value satisfies a threshold difference and whether the first temperature range is within a system temperature range supported by the memory system; and
update the second temperature range by adjusting the stored set of one or more parameter values in response to determining that the difference satisfies the threshold difference and that the first temperature range is within the system temperature range.

21. The non-transitory computer-readable medium of claim 13, wherein the indication comprises a vendor-unique command.

22. A method by a memory system, comprising:
receiving an indication of a set of one or more parameter values that defines a first temperature range associated with operation of the memory system;
storing the set of one or more parameter values to one or more registers of the memory system;
determining whether a temperature value of the memory system is within a second temperature range, wherein a portion of the second temperature range is within the first temperature range; and
refreshing one or more memory cells in response to the temperature value of the memory system being within the portion of the second temperature range and in response to data written to the one or more memory cells at a corresponding temperature value that exceeds the second temperature range.
